(19) United States
(12) Patent Application Publication
(10) Pub. No.: US 2021/0364014 A1
(43) Pub. Date: Nov. 25, 2021

(54) CAVITATION FREE ROTARY MECHANICAL DEVICE WITH IMPROVED OUTPUT

(71) Applicant: HENRY YOUNG & SONS PROPRIETARY LIMITED, Myrtle Bank (AU)

(72) Inventor: Henry S.C YOUNG, MYRTLE BANK (AU)

(21) Appl. No.: 16/980,827

(22) PCT Filed: Mar. 13, 2019
(86) PCT No.: PCT/AU2019/050227

§ 371 Date: Sep. 14, 2020

(30) Foreign Application Priority Data
Mar. 15, 2018 (AU) 2018900861

(51) Int. Cl. F04D 29/66

(52) U.S. Cl. CPC F04D 29/669

(57) ABSTRACT

The present invention relates to a cavitation free rotary mechanical device with improved output and, in particular, to a rotary mechanical device (such as a hydro turbine, marine propeller, etc) including a rotatable shaft and associated blades (or cups or vanes), the rotary mechanical device configured to introduce air at one or more areas of extremely low pressure force on the surface of, or at least in the proximity of, the rotatable blades (or cups or vanes) during rotation and thereby prevent cavitation effects that would otherwise be caused by the extremely low pressure forces acting on such surfaces during operation.

### FIELD OF THE INVENTION

The present invention relates to a cavitation free rotary mechanical device with improved output and, in particular, to a rotary mechanical hydro device (such as a turbine, propeller, etc) including a rotatable shaft and associated blades or cups, the rotary mechanical device configured to introduce air at one or more areas of extremely low pressure force on the surface of, or at least in the proximity of, the blades/cups during rotation and thereby prevent cavitation effects that would otherwise be caused by the extremely low pressure forces acting on such surfaces during operation. In embodiments where the rotary mechanical device is a hydro turbine runner, efficiencies can be gained by not only eliminating cavitation problems but by increasing output by reducing head and converting friction losses to friction gains. The present invention is applicable to all situations where cavitation may cause a loss of efficiency and damage to rotary mechanical devices such as propellers, pumps, turbines, valves, and the like.

### BACKGROUND OF THE INVENTION

Cavitation damage in rotary mechanical devices, in particular in hydro turbines used in Hydro schemes and a marine environment, is an ever present problem and is responsible for costly routine maintenance and remedial repair. In many cases, the forces, occasioned by the repeated implosions of cavitation, also cause stress damage to bearings, valves, and damage other components in close proximity.

At the present time the only solution is costly dismantle and replacement of damaged components or welding repair with special high strength alloys, as shown in some of the Figures presented herein which show typical damage and previous welding repairs, including for example FIG. 1.

In order to appreciate this invention it is necessary to understand the violent forces liberated by the repeated implosions caused by cavitation. Cavitation is the forming of cavities or voids in a liquid when the pressure in a flow of water drops below the value of the saturated water vapours, which then vaporises water into bubbles of gas. This transformation of water into a gas can be observed when water is boiled but, in this case, is the drop in pressure on the surface of the water, of sufficient intensity, to convert the water into bubbles of vapour.

These cavitation bubbles, in a hydro turbine situation, are carried by the flow of water into an area of high pressure occasioned by the head of water above them. Here the bubbles “implode”, i.e. suddenly collapse, back into a liquid form. The process of a cavitation bubble imploding close to a fixed surface and generating a jet of the surrounding liquid is shown in FIG. 2. This implosion is violent with very strong shock waves and accompanying noise and causes a sudden transient leap in temperature. If the implosion is adjacent to a metal surface this can cause cyclic stress and pitting in an adjoining steel surface. At sea, the force is sufficient to cause damage not only to the propeller but, in some cases, even to the adjoining ship's rudder assembly. FIG. 3 shows an example of cavitation damage on a valve plate for an axial piston hydraulic pump.

In addition to the need to address problems associated with cavitation, there is an opportunity to enhance performance of devices that involve a circular rotary action to harness or exert force.

It is an object of the present invention to overcome at least some of the aforementioned problems or to provide the public with a useful alternative. In particular, the present invention seeks to overcome cavitation and to provide an opportunity to materially improve the efficiency and performance of rotary turbines and the like, of whatever design.

### SUMMARY OF THE INVENTION

In one aspect, the present invention provides a rotary mechanical device configured to harness energy from moving fluid or to utilise energy to move fluid, the rotary mechanical device including a central rotatable shaft, a plurality of blades or cups circumferentially arranged on the shaft, and a means of introducing air, during rotation of the shaft, into one or more areas in fluid adjacent to the blades where air pressure is sufficiently low to cause air to be drawn into the one or more areas.

It is to be understood that reference to “blades” is intended to cover within its scope any similar member arranged on the shaft for the purpose of moving fluid or being moved by fluid, including for example cups or vanes.

In an embodiment, the air pressure is at or close to being sufficiently low to also vapourise the fluid. Accordingly, by introducing air into these low pressure areas (referred to herein at times as “voids”), where cavitation would otherwise typically occur, due to the venturi effect (fast flowing water creating areas of low pressure), the present invention proposes capturing the extremely low pressure forces that typically lead to cavitation, and utilising these same forces to introduce air. The present invention further proposes utilising such forces to advantage, e.g. in the pumping phase of a hydro turbine system, as described in more detail below. At sea, this can lead to the prevention of cavitation which causes rudder and propeller damage and, importantly for submarines, eliminates cavitation noise. It will be appreciated that where cavitation damage or heat affected steel is present in a used rotary mechanical hydro device, this identifies a low pressure area that is sufficiently intense to vapourise fluid (e.g. water) so that there is no impediment to introducing air. Depending on the particular installation it is envisaged that air may be sucked in, or alternatively, may be pumped in under pressure where it is considered advantageous to do so.

In an embodiment, the means of introducing air into the one or more areas in fluid adjacent the shaft and/or the blades or cups where the air pressure is sufficiently low to cause air to be drawn into the one or more areas in the fluid, includes a bore extending through the central shaft, and one or more apertures extending from the bore to said one or more areas in the fluid where pressure is sufficiently low to cause air to be drawn in through the bore, wherein the bore and one or more apertures are operable to accommodate a flow of air through the bore and subsequently through the one or more apertures into the one or more low pressure areas.

In an embodiment, the rotary mechanical device is a turbine-type device that operates a pumping phase that uses energy to cause a fluid to move and a generating phase to harness energy when a moving fluid flows past the plurality of blades or cups, or a propeller-type device that uses energy to cause a fluid to move.

In an embodiment, when the rotary mechanical device is a turbine-type device operating a pumping phase or a propeller-type device, the rotary mechanical device includes a drive means for generating energy sufficient to cause the fluid to move.

In an embodiment, the rotary mechanical device is a turbine-type device that forms part of a hydro system that further includes an electrical generator configured to generate electricity during the generating phase when the shaft is caused to rotate by force associated with fluid moving against the plurality of blades or cups that causes the plurality of blades or cups and hence the central shaft to rotate.

In an embodiment, the central shaft is in the form of a hollow shaft including said bore, and air is supplied through the bore from one end of the shaft. The central shaft may be configured such that air in the bore is isolated from the fluid until such time that the air is drawn into the low pressure area(s). For example, the air may be drawn into the bore from the associated drive means end, such as a motor or engine end of the device, which prevents any possible fluid entry with the passage of air completely isolated until drawn into the low pressure area(s).

In an embodiment, an air chamber is attached, for example welded, to an outer rim of the shaft or an outer rim of an associated component such as a bearing, and includes an air valve that allows the supply of air to be pressure controlled to a particular pressure that maximises fluid output. The correct pressure may be determined by factors including the speed of the turbine and a head of water associated with the hydro system. Each installation of such a turbine may be calibrated and controlled using an appropriate control device, such as a digital governor.

### BRIEF DESCRIPTION OF THE DRAWINGS

Features of the present disclosure are illustrated by way of example and not limited in the following figure(s), in which like numerals indicate like elements, in which:

FIG. 1 is a perspective view of a Francis-type turbine at the end of its life showing pitting corrosion, fatigue, cracking and catastrophic failure, as well as earlier repair jobs that used stainless steel weld rods.

FIG. 2 illustrates a schematic of a cavitation bubble imploding close to a fixed surface generating a jet of the surrounding liquid.

FIG. 3 illustrates a perspective view of a valve plate for an axial piston hydraulic pump that includes cavitation damage.

FIG. 4 illustrates a cutaway view of an anti-cavitation rotary mechanical device in the form of a Kaplan-type turbine together with an electrical generator, the rotary mechanical device configured in accordance with an embodiment of the present invention, and an enlarged cutaway view of an alternative arrangement of the section of pipework above the electrical generator including a threaded pipe attached above the bearing and an air valve configured to engage the threaded pipe and thereby create an air chamber;

FIG. 5 illustrates a front, cross-sectional view of the Kaplan-type turbine of FIG. 4 illustrating a rope void from the hub and the introduction of air into the rope void;

FIG. 6 illustrates a side, cut-away view of an anti-cavitation rotary mechanical device in the form of a Francis-type turbine runner configured in accordance with an embodiment of the present invention, wherein areas of erosion that would otherwise typically result from use of the runner are identified.

FIG. 7 illustrates an enlarged perspective view of an anti-cavitation rotary mechanical device in the form of a Francis turbine configured in accordance with an embodiment of the present invention.

FIG. 8 illustrates a perspective view of an anti-cavitation rotary mechanical device in the form of a propeller-type runner configured in accordance with an embodiment of the present invention.

FIGS. 9-10 illustrate photos of damage that is typically caused to blades as a result of cavitation, including areas of heat-affected steel as a direct result of cavitation.

FIG. 11 illustrates cavitation rope voids that typically occur in a Francis-type turbine discharge ring at high (left hand side image) and low (right hand side image) discharge operation.

FIG. 12 illustrates a perspective view of a hydro turbine runner that has been damaged due to cavitation.

FIG. 13 illustrates a schematic visualisation of cavitation vortexes in a turbine runner.

FIG. 14 illustrates a top view of an anti-cavitation rotary mechanical device in the form of an impeller modified to include a bore in the main shaft for introducing air into the low pressure regions behind each impeller blade in accordance with an embodiment of the present invention.

FIG. 15 illustrates an exploded perspective view of the impeller of FIG. 14.

FIG. 16 illustrates a perspective view of an anti-cavitation rotary mechanical device in the form of a marine propeller including coned blades with air introduced through a bore in the main shaft of the propeller into the low pressure rope void area extending from the propeller hub in accordance with a further embodiment of the present invention.

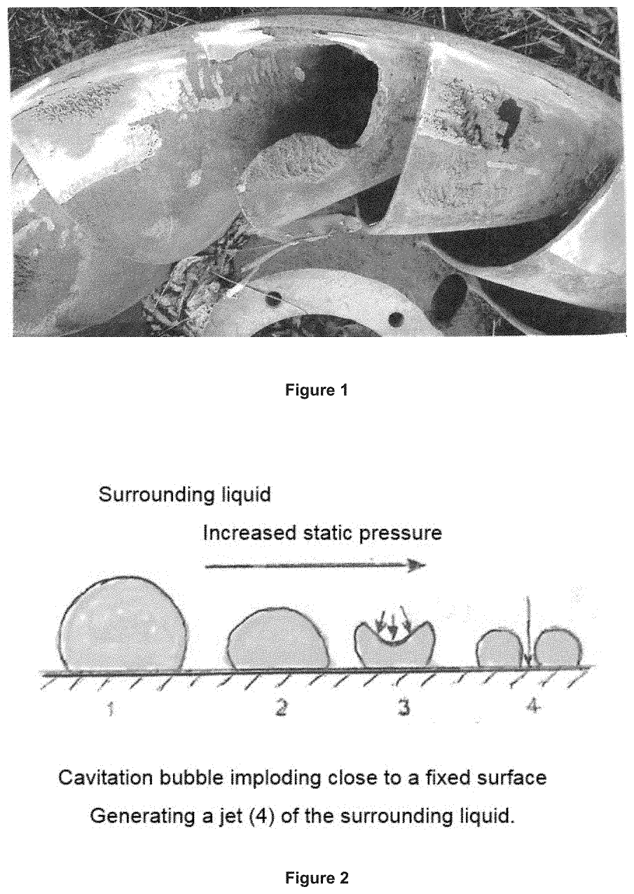

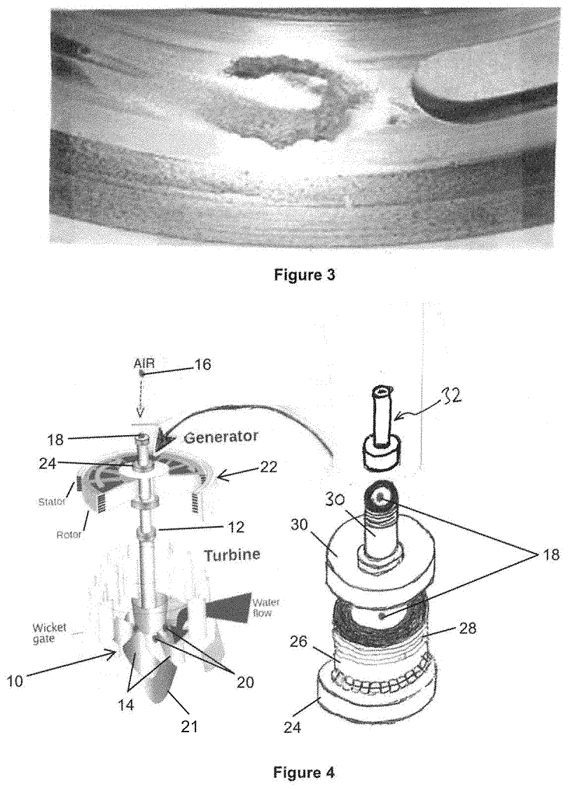

### DETAILED DESCRIPTION OF THE EMBODIMENT(S) OF THE INVENTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

The present invention relates to a rotary mechanical device 10 including a central rotatable shaft 12, a plurality of blades (or cups or vanes) 14 circumferentially arranged on the shaft 12, and a means of introducing air 16, during rotation of the shaft 12, into one or more areas 17 in the fluid adjacent the blades (or cups or vanes) 14 where the air pressure is sufficiently low to cause air to be drawn into the one or more areas in the fluid. The means of introducing air into the one or more areas in the fluid where air pressure is sufficiently low to cause air to be drawn into the one or more areas in the fluid includes a bore 18 extending through the central shaft 12, and one or more apertures 20 extending from the central shaft 12 to said one or more areas in the fluid, wherein the bore 18 and one or more apertures 20 are operable to accommodate a flow of air through the bore and subsequently through the one or more apertures 20 into the one or more low pressure areas.

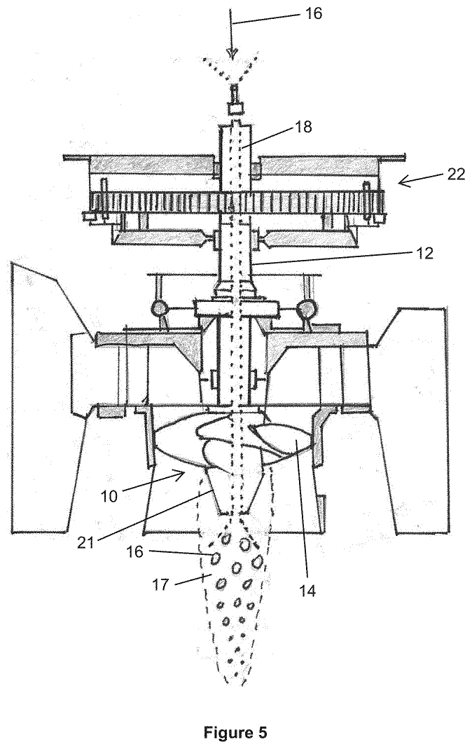

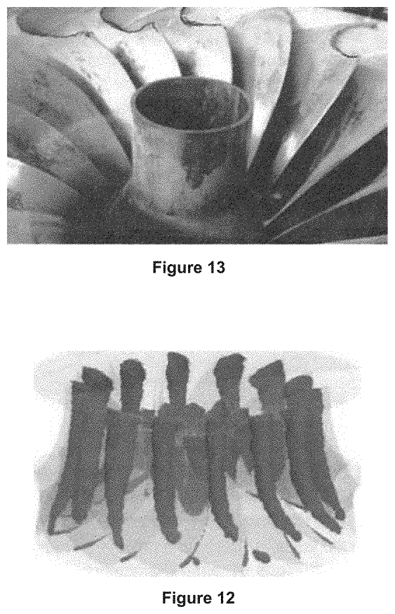

The devices 10 of FIGS. 4-5 illustrate example rotary mechanical devices 10 according to embodiments of the present invention, in particular, Kaplan turbine-type devices 10 wherein the device 10 shown in FIG. 4 includes a bore 18 which branches into a plurality of apertures 20 associated with blades 14 (i.e. into “void” areas associated with the blades, such as those shown in FIG. 12), in contrast to the device 10 shown in FIG. 5 which includes a bore 18 and a single central aperture 20 associated with the propeller hub 21 (i.e. into a single “rope void” area 17 associated with the hub such as that shown in FIG. 11) but not the blades 14.

In an embodiment, the pressure is sufficiently low to not only enable air to be drawn in through the bore 18, but is also at or at least close to a pressure that is sufficiently low to vapourise the fluid. In other words, the device 10 is configured to introduce air into low pressure regions adjacent the blades, irrespective of whether the pressure is sufficiently intense to cause cavitation. However, the air may be introduced in regions adjacent the blades or cups 14 where pressure is sufficiently low to enable air to be drawn in through the bore 18 and also sufficiently low to vapourise the fluid, i.e. at a pressure that would normally cause cavitation.

Notwithstanding that the Figures presented herein illustrate different types of rotary mechanical devices, including for example different turbines and propellers, the same reference numerals are used to describe similar features in the interest of brevity.

The Kaplan turbine-type devices of FIGS. 4 and 5 may form part of a hydro system that further includes an electrical generator 22 configured to generate electricity during a generating phase when the shaft 12 is caused to rotate by force associated with fluid moving against the plurality of blades 14 that causes the plurality of blades 14 and hence the central shaft 12 to rotate. The operation of the electrical generator and the turbine will not be described herein since the manner in which fluid causes rotation of the blades and the manner in which electricity is generated by rotation of the shaft 12 is considered well known by those skilled in the art. The Kaplan-type device also operates a pumping phase for pumping fluid from a lower reservoir (not shown) back up to an upper reservoir (not shown), and this applies also to other hydro turbines such as Francis, Turgo, Pelton, etc.

As described earlier, embodiments of the present invention may give rise to removal or minimisation of inefficiencies in a hydro turbine scenario, not only eliminating cavitation problems, but also increasing output by reducing head and converting friction loss to friction gain during the pumping phase. Just as cavitation problems can be reduced or eliminated, so also can implementations of the present invention be used to induce and capture the forces generated in inception cavitation episodes to enhance performance in devices that involves a circular rotary action when harnessing or exerting force.

In most turbines, the rotary action propels the liquid from the leading edge of the blade, not in a straight line, but because of the centrifugal moment, tangentially across the blade. This leaves an expanding void 17, close to the centre of rotation. It is into this low pressure venturi area that the abovementioned apertures 20 may be located (in newly manufactured devices) or introduced (in existing devices) to introduce air.

These low pressure areas 17 also occur in propellers, and at sea the propeller void area is typically filled in with steel or wood to streamline and approximate as closely as possible, an average speed of the vessel being propelled. However, this void area changes shape in sympathy with the speed of the turbine so that, in a marine environment, cavitation can still take place with damage to both the propeller and the adjoining rudder in circumstances where the turbine is operating at speeds other than the average speed. In submarines the noise accompanying cavitation is a particular problem.

It is to be understood that the present specification will not attempt to identify all those areas 17 where air could or should be introduced in the many pumps, turbines, propellers, valves, etc. These areas can easily be ascertained since they are distinctly marked, in most cases by the heat discolouration as well as the cavitation damage of used rotary devices.

FIG. 4 also illustrates in an enlarged view of an embodiment wherein an air chamber is provided at the top of the central shaft 12 above the top bearing 24 associated with the shaft 12. In this embodiment, a pipe section 26 is attached (welded) to a stationary outer rim of the top bearing 24, and has a male threaded portion 28 associated therewith. In this way, the pipe section 26 is configured to engage the female threaded portion (not shown) of a cap 30 onto which a valve 32 is attached, and thereby create an air chamber. The air valve allows the supply of air to be controlled to a particular pressure that maximises fluid output in the hydro system. The correct pressure may be determined by factors including the speed of the turbine and a head of water associated with the hydro system. Each installation may be calibrated and controlled using an appropriate control device, such as a digital governor (not shown). Different installations may require air to be supplied at different pressures into the bore 18, and the use of a valve 32 accommodates this requirement, however, it is to be understood that other pressure regulating apparatus or no pressure regulating apparatus could be utilised.

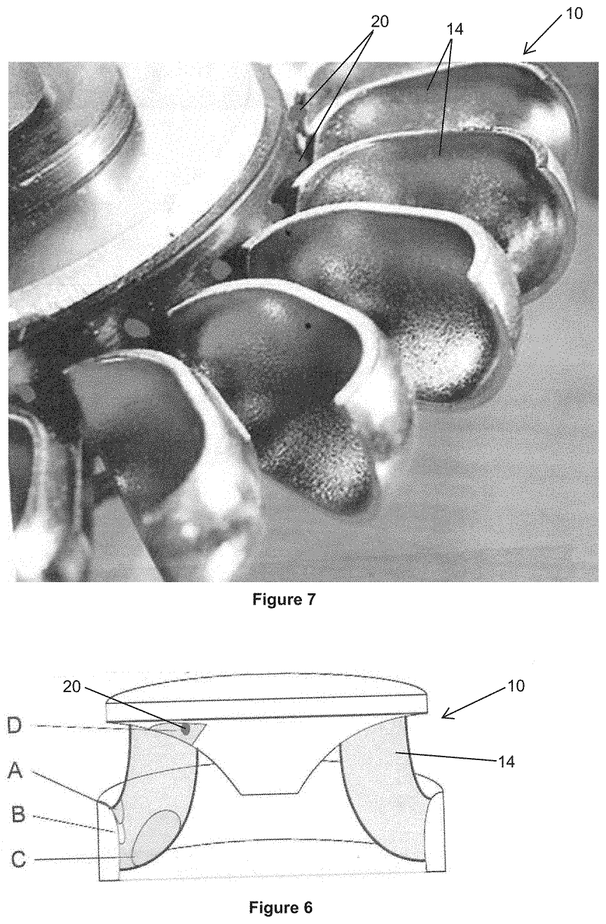

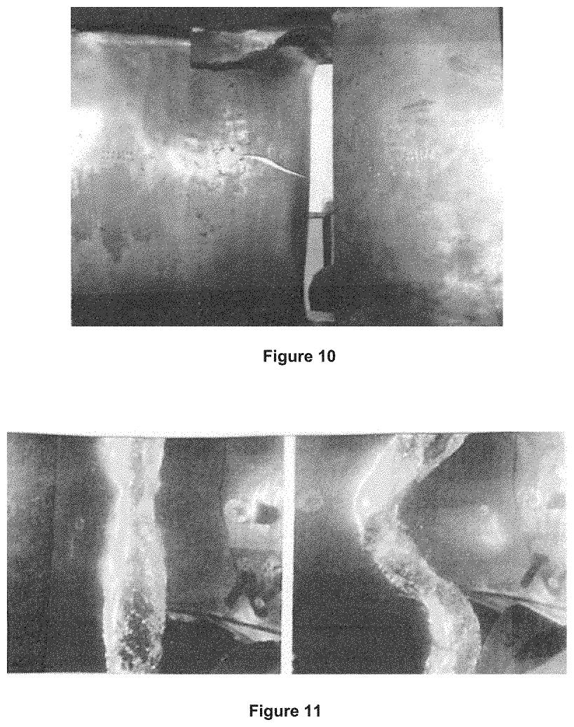

FIG. 6 illustrates a Francis-type turbine according to another embodiment of the invention (shaft not shown), wherein the flow of fluid is radially in and axially out. Accordingly, for Francis-type turbines, in both the pumping and generating phases, the water is directed inwards. Here, air may be introduced through tubing, channelling or drilling from a central shaft bore (equivalent to bore 18 of FIGS. 4-5) to those areas where cavitation has been shown to cause stress damage, such as areas A-D as shown in FIG. 6. These areas are easily identified by the heat damage causing red discolouration (as shown in the photo illustrations of FIGS. 9 and 10 for example). Just as in an aeroplane where small voids migrate to the wingtip, so can this characteristic be employed along the trailing edge of a turbine blade or cup (an example cup-blade turbine indicating example locations of apertures 20 shown in FIG. 7).

Air, once introduced into these low pressure areas during a pumping phase of a hydro turbine, for example, is then sucked into the main stream where each bubble is immediately reduced to a size compatible with the head of water above it. Each bubble of air replaces a similar volume of water in the enclosed column (not shown) above it. The number of bubbles is enhanced by a spiralling moment, induced by the turbine, and, as each bubble progresses up the column, it increases in size in direct sympathy to the decreasing head above it and, therefore, expels more water at the exit. This replacement of water to air reduces the weight of water in the cylinder, i.e. the head, so that, for the same power, the speed of the turbine increases. Accompanying this there is a lifting moment. It will be appreciated that the bubbles do not assume a streamlined dart shape. They are being pushed up by the greater weight of water surrounding them so that the resultant ball shape significantly enhances the friction effect as each bubble is expelled up the cylinder which, again, reduces the head, and hence, enhances the speed of the turbine.

According to an embodiment, in the Francis-type turbine of FIG. 6, there is another low pressure area where air can be introduced. This is from the centre of the high speed runner where the high speed rotation initiates a “rope void” effect (refer also FIG. 11 and associated description below) into which air can be sucked to be immediately compressed without effecting, in any way, the water input. Air introduced behind each blade at D may migrate to all the other low pressure areas A, B and C.

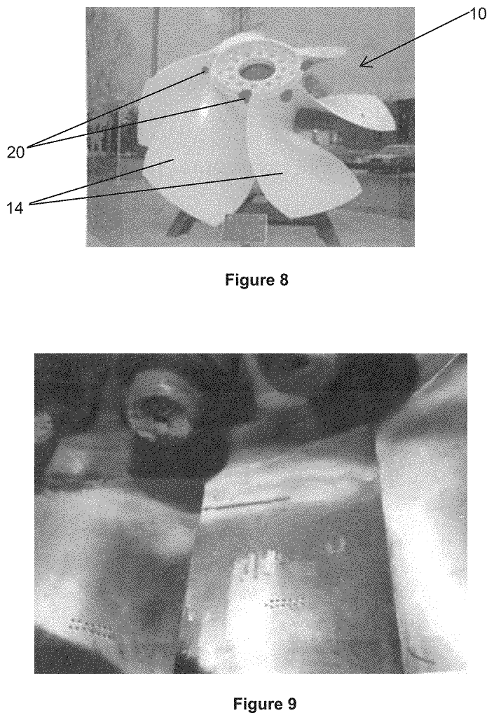

As mentioned earlier, when using a propeller, the void area is typically filled in with steel or wood to streamline and approximate, as closely as possible, an average speed of the vessel being propelled. Whether at sea or land the void area changes shape in sympathy with the speed of the propeller and this inexactitude lessens performance and can lead to cavitation and subsequent stress damage. A propeller 10 according to a further embodiment of the present invention (shaft not shown) is shown in FIG. 8, and it will be appreciated that air can be introduced advantageously through apertures 20, as shown in FIG. 8.

Wherever cavitation is involved there are massive implosions with all the forces that are then liberated, and there is noise and there is heat. The heat is sufficient to discolour the steel which, of course, weakens. Shown in FIGS. 8 and 9 are photos of the type of damage that cavitation can cause. The FIG. 9 photo shows the heat discolouration and a crack forming and the FIG. 10 photo shows the blade broken away. The significance of these photos is that it is from an analysis of the damages to used turbine blades and propellers that the areas of low pressure and hence places to introduce air may be identified. These are areas of sufficient low pressure to cause cavitation, discolour steel and vaporise water. There is no problem introducing air into such areas since it is massively sucked in and will distribute to those other areas wherever needed.

Shown in FIG. 11 is how a rope void (also known as a cavitation whirl) can change with different speeds from a relatively stable column (high discharge operation in a Francis-type turbine discharge ring) to a writhing, twisting void (low discharge operation in a Francis-type turbine discharge ring) with all the pressure changes that accompany it. Here air can be easily introduced to, again, speed up the turbine by substituting water for air which reduces the head and substitutes friction loss for friction gain. Also shown in FIG. 12 is an illustration of the voids (also known as cavitation vortexes) associated with a turbine runner, which is described in more detail below.

As mentioned earlier with respect to the embodiment of FIG. 6, there is another low pressure area where air can be introduced to major advantage. This is wherever high speed rotation causes a rope void effect into which air can be sucked to be immediately compressed without in any way affecting the water input. The rope void effect is particularly damaging as it is constantly whipping around and changing shape leading to constant pressure fluctuations and accelerating fatigue stress which, always, concentrate to the weakest point.

The advantages afforded by implementations of the present invention would now be appreciated by those skilled in the art. The features of the rotary mechanical devices 10 presented and described herein, particularly those embodiments involving hydro power generation, decrease cost by increasing the speed of pumping for the same power, eliminate the damage and major costs associated with cavitation, and converts friction loss to friction gain while leaving intact the generating revenue. FIG. 13 shows cavitation damage to a hydro runner, and in the photo, there is shown four runner tips similarly broken (FIG. 12 illustrating the voids that cause cavitation). The significant benefits associated with preventing such damage would be appreciated by those skilled in the art.

Most hydro turbines are normally situated below an upper and lower water holding area and during the pumping phase water is drawn out of the lower water holding area through a draft tube extending slightly below the lower reservoir, lake or stream. Here again air can be introduced during the pumping phase to, not only reduce the negative friction effect, during this phase, but, to enable friction to become positive. During the generating phase, if the distance to the lower storage or river is considerable, to obviate the air coalescing and running along the top of the channelling, to achieve greatest friction effect, on this almost horizontal piping, it may be advantageous to introduce vanes or other devices to maintain the rotational effect of the bubbles. All these factors, in a hydro situation, decrease cost, by increasing the speed of pumping, for less power, while leaving intact the income generating component.

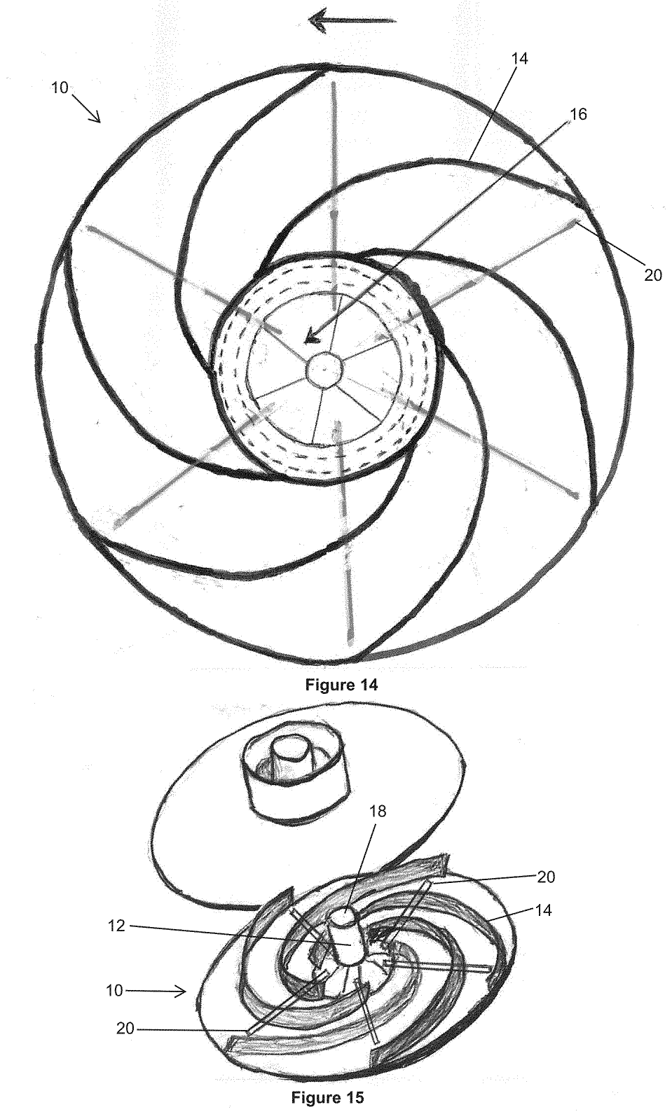

FIGS. 14 and 15 illustrate yet another example of a mechanical rotary device that may utilise the present invention to advantage, in particular, a pump impeller type device 10 which includes a central bore 18 that branches into apertures 20 configured to introduce air into appropriate low pressure areas associated with each vane 14 of the impeller. The advantages associated with introducing air into these void areas are the same as those described previously in this specification in respect of the earlier described embodiments, hence will not be described again.

At sea, void effects from propeller blades and the rope void effect from the hub can cause damage not only to the propeller but also to the rudder assembly in close proximity. This can be eliminated by introducing air through the shaft to behind the blades 14 and/or through the hub 21, as described earlier with respect to FIG. 8.

The first main wastage area in conventional propeller driven ships is when water passes over the blades at a tangent, and not a right angle, due to the centrifugal moment of the swiftly rotating blades. The action force, being applied at a tangent has the reaction force also applied at a tangent (akin to a two passenger car being towed by passengers pushing on each side of the car). Whilst this can be done, it is at a loss. This is how every conventional ship known to the Applicant is propelled forward, that is, by the amalgam of tangential forces on opposite blades of the propeller.

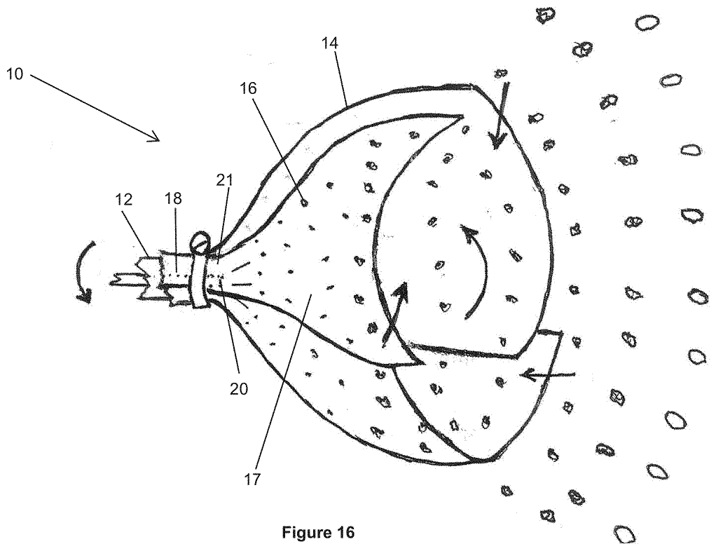

The second main wastage area in conventional propeller driven ships is that the only 100% efficient application of force along a propeller blade is the tip. This is where each blade travels at maximum speed and covers the most area for each revolution. In turbine pumps, an impeller overcomes this deficiency by moving all the water it impels to the perimeter but this can also be achieved in a blade situation by moving the water into the centre by coning the blades as per the propeller 40 shown in FIG. 16. In this embodiment, water (being inert) has no option but to speed up due to the shape of the blades. There is a rope void area 17 from the hub 21 and it is into this low pressure area that air is drawn and is immediately compressed, as bubbles, into a size exactly commensurate with the pressure that surrounds them. It will be appreciated that this pressure, e.g. propelling a 2,000 passenger cruise liner, can be very significant and, unlike in the hydro application where bubbles expand over say 200-300 metres, these bubbles expand explosively over 2-3 metres. It also overcomes the inert status of water which now becomes a resilient commodity that can be stretched, compressed and able to have energy stored in it to be released at will, in this case almost immediately.

In addition to correcting these significant examples of waste, there is an opportunity to take full advantage of the removal of limitations previously imposed by cavitation. As mentioned above, the only efficient part of a propeller is the fast moving tip, and by utilising the present invention the blade length constraint is effectively removed and hence the length of the propeller, i.e. the leverage, may be maximised. The length of a propeller blade is normally determined by cavitation constraints and any increase in length leads to greater speed of rushing water with the inevitable increased incidence of cavitation. In many instances, propeller speed is geared down specifically to avoid cavitation, however, by implementing the present invention this limitation is no longer applicable.

While, for simplicity, water has been used for illustration purposes this invention applies equally for all fluids, e.g. oil, slurries, dispersants, foam etc and is applicable wherever inertial, non-inertial super suction, hydrodynamic or inception cavitation applies. The invention may also be applicable with respect to concrete spillways, waterfalls, engines, hydraulics, industrial cleaning, valves, medical purposes and wherever the introduction of air to a device or situation can be shown to be advantageous.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1-26. (canceled)

27. A cavitation-free rotary mechanical device including:
a hollow shaft or cylinder having a longitudinal axis and including an internal space extending longitudinally through the shaft or cylinder, the shaft or cylinder including:
a first end that enables supply of gas longitudinally through the internal space from the first end, and
a second end;
a plurality of blades configured to rotate about said longitudinal axis at or adjacent to the second end of the shaft or cylinder;
one or more apertures or chambers in fluid communication with the internal space which enable delivery of gas from the internal space of the shaft or cylinder into fluid adjacent the blades; and
a drive means operable to cause the plurality of blades to rotate,
wherein the drive means and the shaft or cylinder are arranged such that supply of gas longitudinally from the first end through the internal space is not restricted by the drive means, and
wherein the one or more apertures or chambers are arranged to cause gas to be delivered into one or more void areas in the fluid where pressure is at or near to being sufficiently low to vaporise the fluid in the one or more void areas, the gas forming bubbles in the fluid which subsequently compress to a pressure that corresponds with the pressure of surrounding fluid and then continually expand such that each bubble replaces an equivalent volume of fluid and thereby maintains a continuous wave of pressure.

28. A rotary mechanical device according to claim 27, wherein the hollow shaft or cylinder terminates in a hub at the second end, and the one or more void areas includes a single rope void area associated with the hub.

29. A rotary mechanical device according to claim 27, wherein the one or more void areas are at low pressure areas behind one or more of the plurality of blades, wherein each blade includes said one or more chambers or apertures for delivering gas from the internal space into the one or more void areas.

30. A rotary mechanical device according to claim 29, wherein the one or more void areas are at or adjacent a tip of each of the plurality of blades.

31. A rotary mechanical device according to claim 27, wherein the rotary mechanical device is:
a turbine-type device that operates a pumping phase that uses energy to cause a fluid to move.

32. A rotary mechanical device according to claim 31, wherein the turbine-type device is a pump impeller.

33. A rotary mechanical device according to claim 27, wherein the rotary mechanical device is:
a propeller-type device that uses energy to cause a fluid to move.

34. A rotary mechanical device according to claim 27, wherein the drive means is an electric motor operable to cause the plurality of blades to rotate.

35. A rotary mechanical device according to claim 27, wherein the plurality of blades form a hollow, three-dimensional structure at the second end of the shaft or cylinder, the hollow three-dimensional structure increasing in lengthwise cross-sectional dimension from a proximal end that is connected to the second end of the shaft or cylinder to a distal end that is surrounded by said fluid, the three-dimensional structure shaped to direct fluid radially inwardly and thereby cause forces associated with the continuous wave of pressure to collide resulting in a momentary increase in pressure.

36. A rotary mechanical device according to claim 35, wherein the hollow, three-dimensional structure is substantially cone-shaped, wherein the tangential edge of each blade overlaps with a tangential edge of an adjacent blade to facilitate entry of fluid.

37. A rotary mechanical device according to claim 27, wherein gas that is delivered through the internal space from the first end of the shaft or cylinder is free, fan-forced or compressed air.

38. A rotary mechanical device according to claim 37, wherein entry of free air into the internal space through the first end of the shaft or cylinder is facilitated by the pressure in the one or more void areas being sufficiently intense to cause air to be drawn from the internal space into the one or more void areas.

39. A rotary mechanical device according to claim 37, wherein fan-forced air is delivered into the internal space through the first end of the shaft or cylinder by reversing a cooling fan associated with the drive means to create a positive pressure that facilitates entry of air into the first end of the shaft or cylinder.

40. A rotary mechanical device according to claim 37, wherein an air chamber is attached to an outer rim of the shaft or cylinder, or an outer rim of an associated component, and includes an air valve that enables the supply of air to be pressure controlled to a particular pressure.

41. A rotary mechanical device including:
a hollow shaft or cylinder having a longitudinal axis and including an internal space extending longitudinally through the shaft or cylinder, the hollow shaft or cylinder including:
a first end that enables supply of gas through the internal space, and
a second end;
a plurality of blades configured to rotate about the longitudinal axis at or adjacent to the second end of the shaft or cylinder; and
one or more apertures or chambers in fluid communication with the internal space which enable delivery of gas from the internal space of the shaft or cylinder into fluid adjacent the blades,
wherein the one or more apertures or chambers are arranged to cause gas to be delivered into one or more void areas in the fluid where pressure is at or near to being sufficiently low to vaporise the fluid in the one or more void areas, the gas forming bubbles in the fluid which subsequently compress to a pressure that corresponds with the pressure of surrounding fluid and then continually expand such that each bubble replaces an equivalent volume of fluid and thereby maintains a continuous wave of pressure; and
wherein the plurality of blades form a hollow, three-dimensional structure at the second end of the shaft or cylinder, the hollow three-dimensional structure increasing in lengthwise cross-sectional dimension from a proximal end that is connected to the second end of the shaft or cylinder to a distal end that is surrounded by said fluid, the three-dimensional structure shaped to direct fluid radially inwardly and thereby cause forces associated with the continuous wave of pressure to collide resulting in a momentary increase in pressure.

42. A rotary mechanical device according to claim 41, wherein the hollow, three-dimensional structure is substantially cone-shaped, wherein the tangential edge of each blade overlaps with a tangential edge of an adjacent blade to facilitate entry of fluid.

43. A rotary mechanical device according to claim 41, wherein the hollow shaft or cylinder terminates in a hub at the second end, and the one or more void areas includes a single rope void area associated with the hub.

44. A rotary mechanical device according to claim 41, wherein the rotary mechanical device is:
a turbine-type device that operates a pumping phase that uses energy to cause a fluid to move.

45. A rotary mechanical device according to claim 41, wherein the rotary mechanical device is:
a propeller-type device that uses energy to cause a fluid to move.

46. A rotary mechanical device according to claim 41, wherein the first end of the shaft or cylinder enables supply of gas longitudinally through the internal space from the first end.

47. A rotary mechanical device according to claim 41, further including:
a drive means operable to cause the plurality of blades to rotate,
wherein the drive means and the shaft or cylinder are arranged such that supply of gas longitudinally from the first end through the internal space is not restricted by the drive means.

48. A rotary mechanical device according to claim 41, wherein the drive means is an electric motor.

49. A rotary mechanical device according to claim 41, wherein gas that is delivered through the internal space from the first end of the shaft or cylinder is free, fan-forced or compressed air.

50. A rotary mechanical device according to claim 49, wherein entry of free air into the internal space through the first end of the shaft or cylinder is facilitated by the pressure in the one or more void areas being sufficiently intense to cause air to be drawn from the internal space into the one or more void areas.

51. A rotary mechanical device according to claim 49, wherein fan-forced air is delivered into the internal space through the first end of the shaft or cylinder by reversing a cooling fan associated with the drive means to create a positive pressure that facilitates entry of air into the first end of the shaft or cylinder.

52. A rotary mechanical device according to claim 49, wherein an air chamber is attached to an outer rim of the shaft or cylinder, or an outer rim of an associated component, and includes an air valve that enables the supply of air to be pressure controlled to a particular pressure.
